(19) United States
(12) Patent Application Publication
(10) Pub. No.: US 2008/0048010 A1
(43) Pub. Date: Feb. 28, 2008

(54) Clading complex piping geometry

(76) Inventors: Patrick J. Brousset, Lynchburg, VA (US); Ronald J. Payne, Forest, VA (US); John A. Orr, Lynchburg, VA (US); Charles A. Graves, Lynchburg, VA (US)

Correspondence Address: VYTAS R. MATAS, 2412 CEDARWOOD RD., PEPPER PIKE, OH, 44124, US

(21) Appl. No.: 11/825,613

(22) Filed: Jul. 7, 2007

Related U.S. Application Data
(60) Provisional application No. 60/819,304, filed on Jul. 8, 2006.

(51) Int. Cl. B23K 37/04

(52) U.S. Cl. 228/212; 228/44.3

(57) ABSTRACT

A mounting fixture for a power plant nozzle which allows the user to perform a single set-up and alignment on a nozzle location for overlay, matching, and inspection technologies. Once the fixture is set-up, the user can mount and dismount welding, machining, and inspection equipment in less time than traditional motion systems would require.

### BACKGROUND OF THE INVENTION

1. Field of the Invention

The present invention generally relates to weld overlay of power plant nozzles and more particularly to fixtures mounted on nozzle piping for performing such overlay welding or other operations.

2. Description of the Prior Art

As the existing fleet of commercial nuclear power plants has aged, the occurrence of Primary Water Stress Corrosion Cracking (PWSCC) of Alloy 600 and its associated weld metals has increased. Nuclear power plant operators are looking at mitigation of PWSCC through material replacement, stress reversal, and altering the primary water chemistry. Weld overlay is a popular technology that offers both the benefit of stress reversal with the added benefit of structural reinforcement and the ability to change the piping geometry to aid in inspection. Some Pressurized Water Reactor (PWR) designs incorporated Alloy 600 on the piping to pressurizer nozzle welds and these nozzles are not inspectable by current code requirements. Concerns of SCC of these welds have prompted the operators of these plants to explore weld overlay of these nozzles and associated piping to provide an inspectable geometry and alter the stress state of the material while providing additional structural credit to the piping wall thickness.

Weld overlays of piping are generally performed by mounting a tract to the piping. The welding equipment travels along this tract depositing weld material on the outer diameter OD of the pipe. Piping that has small radius bends cannot be overlaid using this method without using multiple set-ups for the machining, welding and inspection equipment.

To overcome the limitations of conventional machining, welding, and inspection equipment for weld overlays, a programmable motion control system could be utilized to follow the contour of the piping. Although this provides a method for a single set-up on the piping, programming is required for each nozzle location and may have to be adjusted/reprogrammed depending on the as found conditions.

### BRIEF SUMMARY OF THE INVENTION

The purpose of this invention is to simplify the set-up of equipment required for weld overlay on complex piping geometries found on nuclear power plants. The application is for pressurizer nozzles safety/relief nozzles, spray nozzles, and PORV nozzles. Capacitance discharge welding is used to weld studs on the pressurizer walls to mount a fixture that supports attachment thereto of known machining, welding, and inspection equipment. By using a mounting fixture independent of the piping for machining, welding or inspection, a single set-up can be used to perform an overlay weld where as existing systems requires multiple set-up or expensive programmable motion control systems that are application specific.

### BRIEF DESCRIPTION OF THE DRAWINGS

Referring now to the drawings wherein:

FIG. 1 depicts a mockup of a known commercial nuclear power plant pressurizer;

FIG. 2 depicts a perspective view of the mounting fixture of the present invention showing the installation jacking feet assemblies thereon;

FIG. 3 is a perspective view of the FIG. 2 fixture with the jacking assemblies removes to clearly show the ID welding track mounted thereon; and

FIG. 4 is a perspective view of the FIG. 3 fixture mounted on a nozzle pipe with the ID welding track having a known weld head installed thereon for weld overlay welding.

### DETAILED DESCRIPTION OF THE INVENTION

Referring now to the drawings where the depictions are to present one embodiment of the present invention without limiting it to same, the embodiment as described herein is for a stud mounted fixture for fast, simple and reliable setup of equipment for welding and/or machining and/or inspection of weld overlays of a commercial nuclear reactor pressurizer. The advantages of the present fixture embodiment are:

The fixture allows for a single set-up for all weld overlay operations (welding and/or machining and/or inspection); and

The system is not as susceptible to as found conditions as prior art programmable motion control systems.

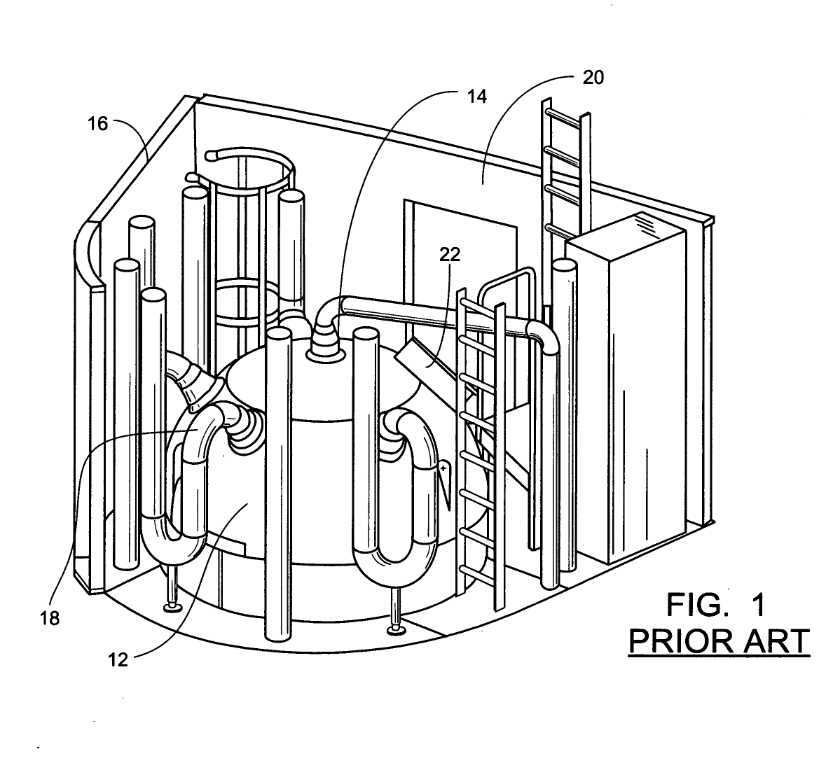

Referring now to the drawings, FIG. 1 shows a mockup of a typical commercial nuclear power plant pressurizer assembly (10). The pressurizer (10) has an upper head (12), a spray nozzle (14), a PORV nozzle (16) and three safety nozzles (18). Each of these nozzles is welded to piping of complex geometry. The figure also shows the general area environment (20) of the pressurizer (10) and a pressurizer manway (22).

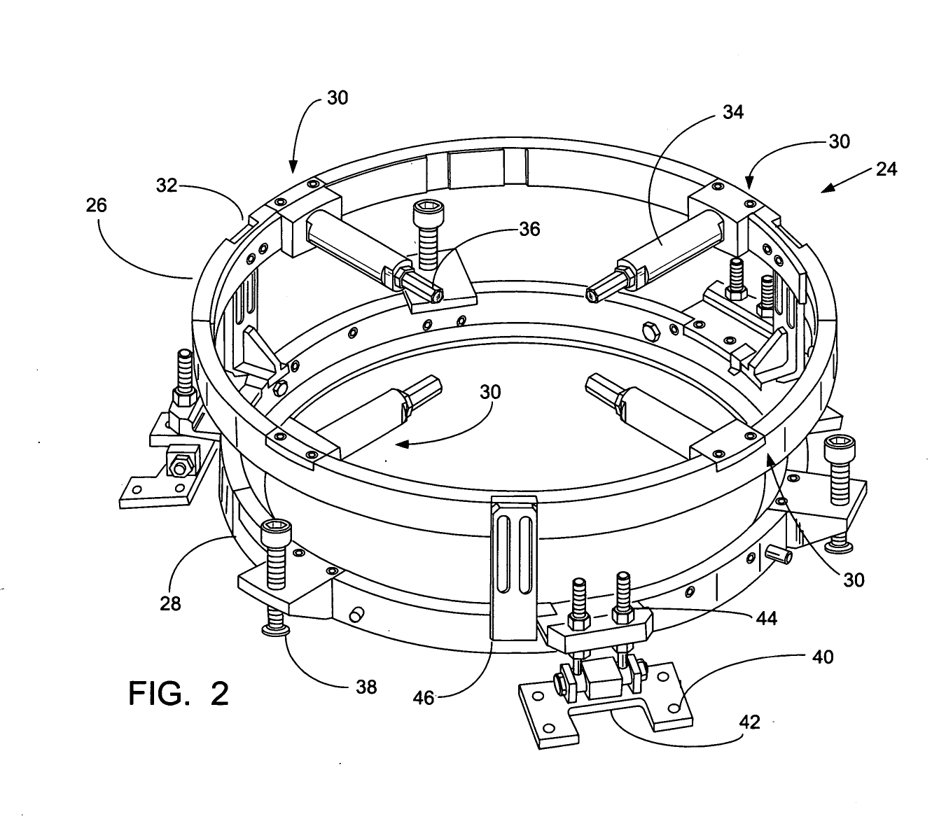

Referring now to FIG. 2, mounting fixture assembly (24) is shown. The installation of the mounting fixture (24) to the pressurizer assembly (10) of FIG. 1 is performed in the following steps:
1. Track fixture assembly (24) is installed onto any of the nozzles of interest detailed in FIG. 1 by either being placed in sections around the nozzle piping or having the nozzle piping disconnected from the nozzle and threaded through the assembly (24) and reconnected. This results in strongback (26) and base ring (28) assembly being settled around the piping and between the installer jacking feet assemblies (30) which consist of a set screw jacking base (32), a jacking extension bar (34), a threaded rod and set screw (36). They can all now be properly moved against the piping to centrally position the piping within the fixture (24). Tightening swivel head screws (38) are provided and may be adjusted on to the pressurizer top surface for additional support.
2. The concentricity and axial alignment of the track strongback (26) to the piping section to be overlaid is then verified.
3. A stud locating template is then positioned along the pressurizer top surface to mark stud locations on the pressurizer, the template is then removed and studs (40) are welded to the pressurizer using a capacitance discharge welder.
4. Lug pads (42) located on the fixture (24) are mounted to the studs using rod end bolting hardware (44) of the fixture (24).
5. The jacking feet assemblies (30) are next removed.
6. The axial position of the strongback (26) to the base ring (28) is adjusted as necessary via support legs (46).
7. Overlay welding or other equipment is mounted to the fixture (24) for weld overlay operations.

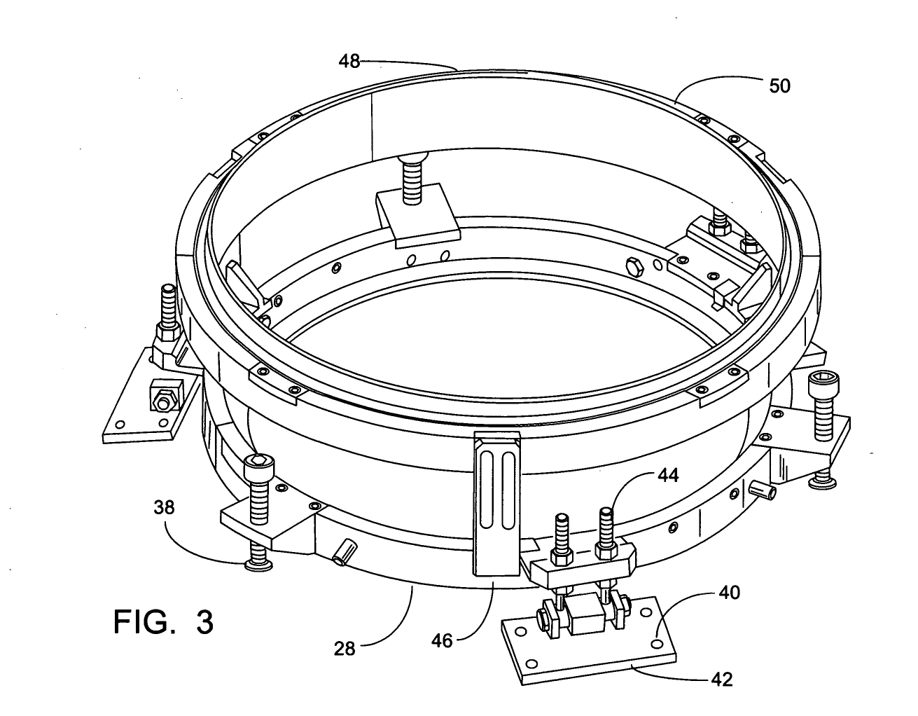

Referring now to FIG. 3, the mounting fixture (24) now shows an ID weld track (48) installed and ready for operation. The base ring assembly (28) has been previously installed to the capacitance discharge welded studs (40) via a lug pad (42) using rod end bolts (44) to secure the base ring assembly (28) and swivel head screws (38) to provide additional support. The ID weld track (48) is installed to the track strongback (50). Axial position of the weld track can be accomplished using the support legs (46) as necessary.

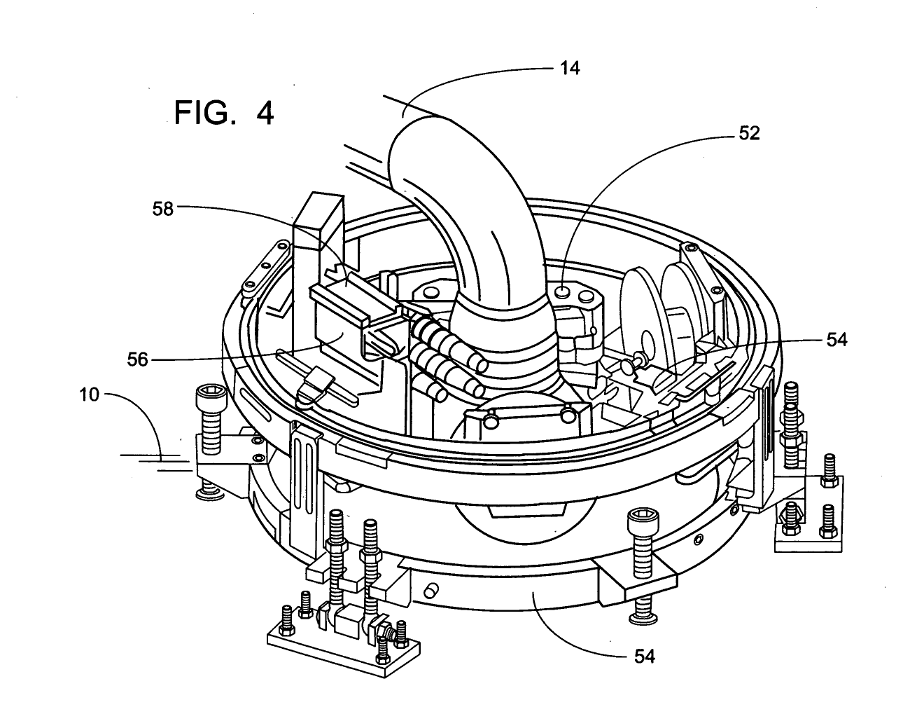

FIG. 4 shows the mounting fixture (24) mounted on a particular nozzle assembly of the pressurizer (10) namely on the spray nozzle (14) location. An ID welding track and weld head are installed on the mounting fixture assembly (24). The illustration shows a welding front end (52) a wire feed mechanisms with wire spools (54) an orbital drive carriage (56), a trailer with Automatic Voltage Control (AVC) and cross-seam axis ((58).

This welding assembly is well known in its design, mounting and operation and will not be detailed herein for the sake of conciseness and readability.

Certain improvements modifications and other changes have been deleted herein but are properly intended to be within the scope of the following claims.

We claim:

1. A method of mounting a circular shaped mounting fixture for overlay welding of power reactor pressurizer nozzle piping having complex piping geometry comprising the steps of:
positioning piping within the circular shaped mounting fixture;
verifying the concentricity and axial alignment of the piping in the fixture using jacking assemblies found on the mounting fixture; marking stud locations for attaching mounting fixture to the pressurizer;
welding studs to pressurizer surface at marked locations;
attaching mounting fixture to welded studs;
removing jacking assembly from the mounting fixture; and
mounting overlay welding assembly on mounting fixture.

2. A method as set forth in claim 1 wherein said mounting fixture comprises a first ring for mounting the fixture to the studs and a second ring for mounting the overlay welding assembly and a series of support legs connecting the two and wherein the axial position of the second ring is adjusted using the support legs after the jacking assembly is removed from the mounting fixture.

3. A mounting fixture for equipment used in weld overlay operations on nozzles of a nuclear power generator pressurizer comprising:
a first ring located around pressurizer piping having stud mounting assemblies thereon for mounting to studs welded to a surface of the pressurizer;
a second ring spaced from said first ring having a series of jacking assemblies located thereon positioned against a pipe connected to said nozzle; and
a series of support legs connecting said first and second ring.

4. A mounting fixture as set forth in claim 3 including a series of swivel head screws connected to said first ring for reinforcing the mounting of said first ring to the pressurizer surface.

5. A mounting fixture for equipment used in weld overlay operations on nozzles of a nuclear power generator pressurizer comprising:
a first ring located around pressurizer piping having stud mounting assemblies thereon for mounting to studs welded to a surface of the pressurizer;
a second ring spaced from said first ring for mounting overlay welding equipment thereto; and
a series of support legs connecting said first and second ring for adjusting their conformity to each other.

6. A mounting fixture as set forth in claim 5 including an overlay welding assembly mounted to said second ring.
